(19) United States
(12) Patent Application Publication
(10) Pub. No.: US 2006/0236869 A1
(43) Pub. Date: Oct. 26, 2006

(54) Air treatment device

(75) Inventors: Frederic Giraud, Le Perray en Yvelines (FR); Laurence Cornu, Saint Arnoult en Yvelines (FR); Gilles Ellliot, Courcouronnes (FR)

Correspondence Address: Valeo Climate Control Corp.;Intellectual Property Dept, 4100 North Atlantic Boulevard, Auburn Hills, MI, 48326, US

(73) Assignee: Valeo Systemes Thermiques S.A.S., Le Mesnil St Denis (FR)

(21) Appl. No.: 11/409,110

(22) Filed: Apr. 21, 2006

(30) Foreign Application Priority Data
Apr. 22, 2005 (FR) 05 04070

(51) Int. Cl. B01D 47/00

(52) U.S. Cl. 96/222

(57) ABSTRACT

The invention relates to an air treatment device 1 using a volatile agent contained inside a casing 2 that is at least partially permeable, characterized in that it includes means 4 for activating the emission of the volatile agent. These means are advantageously constituted by a film, a strip, a cord or a percussor. Application in motor vehicles.

This invention relates to the field of air disinfection, sterilization and/or deodorization, in particular to be applied in ventilation, heating and/or air conditioning systems for motor vehicle cabins. It relates to an air treatment device using a volatile treatment agent housed inside a casing which is at least partially permeable, in particular for treating the air circulating through such a system.

Devices for treating air using a volatile treatment agent placed inside a permeable container, for progressive diffusion of the treatment agent through the wall of the container over a given period, are already known. This treatment is, for example, a fungicidal, antimicrobial or deodorizing treatment.

According to a first known solution, the treatment agent is a liquid contained inside a gas-permeable and liquid-impermeable bag, itself packaged inside an impermeable container that is withdrawn when the device is used. Reference can be made, for example, to document U.S. Pat. No. 4,961,493, which describes such a device.

Conversely, and according to another known solution, the treatment agent is a liquid contained inside an impermeable bag, itself contained in a permeable container. When the device is used, the impermeable bag is broken so as to release the treatment agent into the permeable container. Reference can be made, for example, to document U.S. Pat. No. 5,458,244, which describes such a device.

The problem to be solved is that of the accessibility to this type of container in a ventilation, heating and/or air conditioning system of a new vehicle when the latter is stored on a parking lot for a number of months before being delivered to its purchaser. Indeed, the container is located inside the system, itself located under the dashboard and covered by plastic wheel covers. If the container is activated when the vehicle is being assembled on a chain, it will have a reduced lifetime when the vehicle is delivered to the final purchaser since the vehicles often remain parked for a number of months before being delivered, during which time the container is needlessly emptied. If the container is to be activated at the time of delivery, it is necessary to disassemble numerous parts such as dashboard elements so as to reach the location where the container is installed. These operations are time-consuming and risky and are therefore inappropriate prior to delivery of the vehicle.

These constraints are also encountered when the air treatment device is combined with a filter for the automobile replacement market. It is noted simply in this regard that the container according to prior art is unsuitable for being integrated into a cabin filter because its dimensions have not been designed for this purpose and largely it encroaches on the filtering surface of the filter.

In addition, the needs of automobile manufacturers are not satisfied with regard to standardization between original equipment products and replacement products so as to lower the manufacturing cost while complying with the technical characteristics of the vehicle over the course of its lifetime.

Finally, the device described in prior art document U.S. Pat. No. 5,458,244 is not easy to implement and does not provide assurance with regard to its activation.

The aim of this invention is therefore to overcome the disadvantages described above, in particular by proposing an air treatment device that is simple to produce and that can be activated easily at a predetermined time, for example, immediately prior to delivery of a new vehicle.

The invention therefore relates to an air treatment device using a volatile agent contained inside a casing that is at least partially permeable, characterized in that it includes means for activating emission of the volatile agent.

According to a first feature of the invention, the permeability of the casing is provided by an active surface of said casing through which the volatile treatment agent passes.

According to a second feature of the invention, the active surface is formed by a permeable wall having a lower thickness than the other walls of the casing.

According to another feature of the invention, the means for activating the emission of the volatile agent cooperates with said active surface so as to keep the latter sealed prior to activation of the device.

According to yet another feature of the invention, the means for activating the emission of the volatile agent consist of an impermeable film formed by a first portion covering said active surface and attached in a sealed manner to the periphery of the active zone, and a second free portion accessible to the user so as to activate the emission of the volatile agent.

According to yet another feature of the invention, the second portion of the film is folded over the first portion prior to activation of the means.

According to yet another feature of the invention, the volatile agent is stored in a sealed container arranged inside the casing, in which the means for activating the emission of the volatile agent are capable of breaking the container and enabling the volatile agent to spread into the casing.

According to an alternative of the invention, the active surface is constituted by all of the peripheral walls of the casing.

The sealed container is advantageously a bag provided with at least one weakened wall area so as to facilitate the opening of said bag.

Also advantageously, the means for activating the emission of the volatile agent consist of a cord of which one end is secured to the bag, to the right of a weakened area, and the other end is free, outside the casing, passing through the latter, through a hole so as to be accessible to the user.

The free end of the cord connected to the bag has a seal intended to close said hole after activation of the means.

According to an alternative of the invention, the means for activating the emission of a volatile agent consist of a percussor having at least one perforation point capable of breaking the container.

According to a first feature of the invention, the percussor has a plurality of perforation points or teeth.

According to a second feature of the invention, the percussor is installed at one end of the casing and moves in translation towards the inside of said casing so as to activate the emission of the volatile agent.

According to another feature of the invention, the percussor moves in rotation towards the inside of the casing.

According to yet another feature of the invention, the container is a blister of which one end comes into contact with a shoulder formed on the internal wall of the casing, and the other end is subjected to the translation force of means for activating the emission of the volatile agent.

The container is advantageously a cartridge that can be perforated by at least one needle formed in the internal volume of the casing.

The device has an indicator of the state of the means for activating the emission of the volatile agent.

This state indicator is a break-off head connected to the percussor by a pin so as to be broken by the user when implementing the means for activating the emission of the volatile agent.

Alternatively, the state indicator is a mark applied to the means that shows the activation of the emission of the volatile agent.

The invention also relates to a method for implementing an air treatment device using a volatile agent contained inside a casing that is at least partially permeable, characterized in that the activation of the emission of the volatile agent is effective by one of the following means:
by pulling on an impermeable film so as to expose an active surface of the device, or
by moving a percussor in translation toward the inside of the casing, or
by combining a translation movement with a rotation movement so as to move a percussor.

One first advantage of the invention lies in the possibility of maintaining the device in an inactive, i.e. storage, position, while having the possibility of activating the emission of the volatile agent at a determined moment and by simple means easily accessible to the user.

Another advantage lies in the possibility of standardizing the air treatment device applicable to replacement or original parts of motor vehicles without restricting the filtering surface of the cabin filter.

Other features, details and advantages of the invention will be more clear from the following description given below by way of example, with reference to the drawings in which:

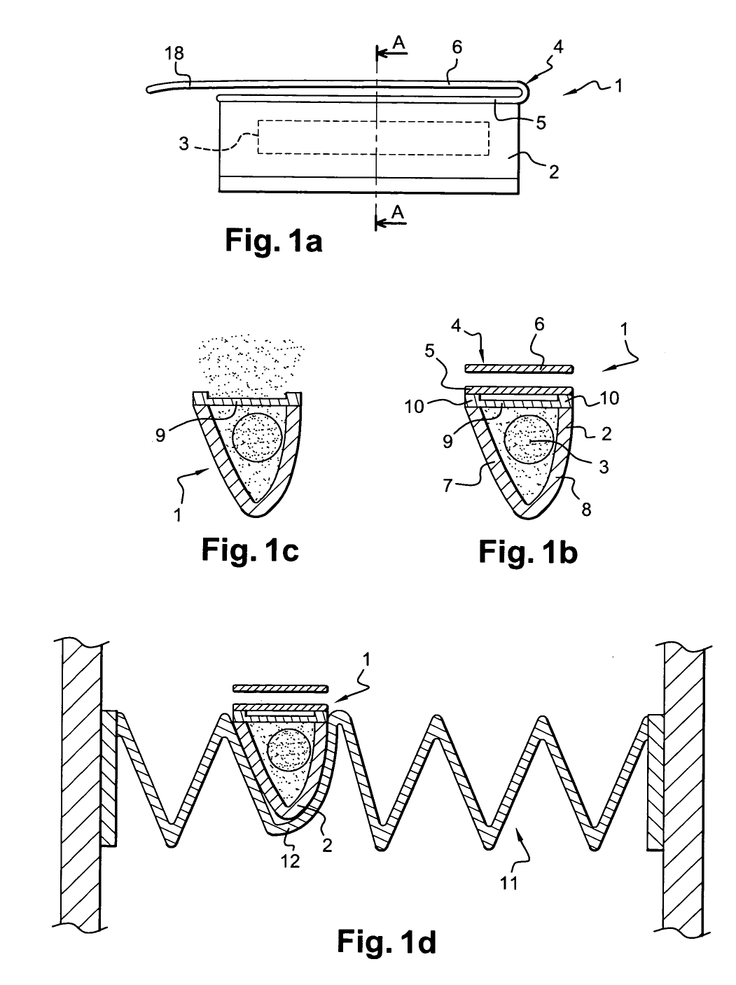

FIGS. 1a to 1d are representations of the air treatment device according to a first alternative of the invention,

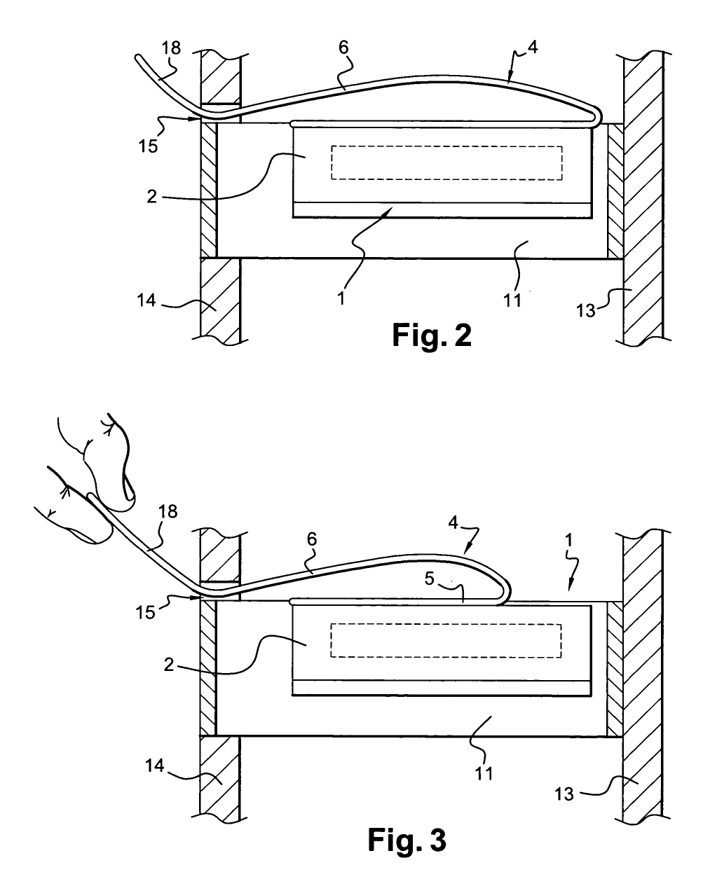

FIG. 2 is a view of the treatment device before activation,

FIG. 3 is a view similar to FIG. 2 in which the means for activating the emission of the volatile agent are being withdrawn,

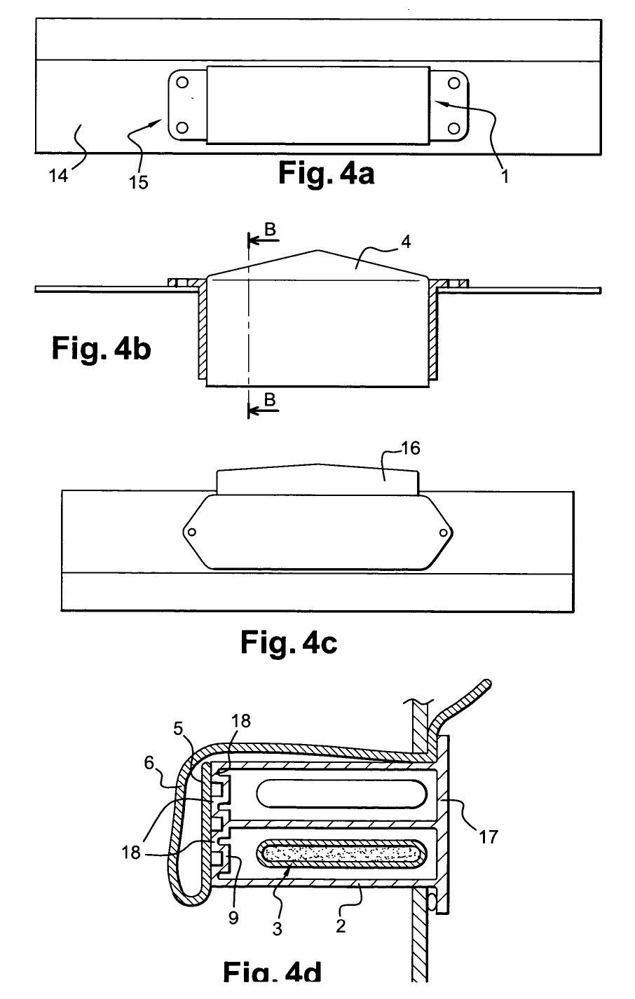

FIGS. 4a to 4d are representations of a second alternative of the device according to the invention,

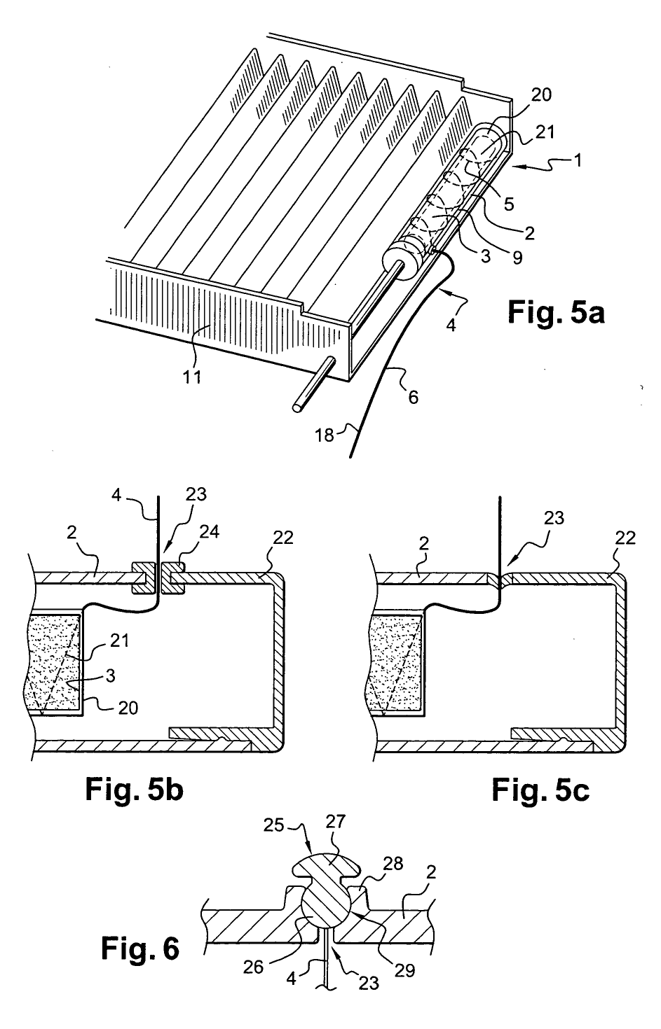

FIGS. 5a to 5c are views showing a third alternative of the air treatment device according to the invention,

FIG. 6 is a representation of the means for closing off the hole formed in the casing,

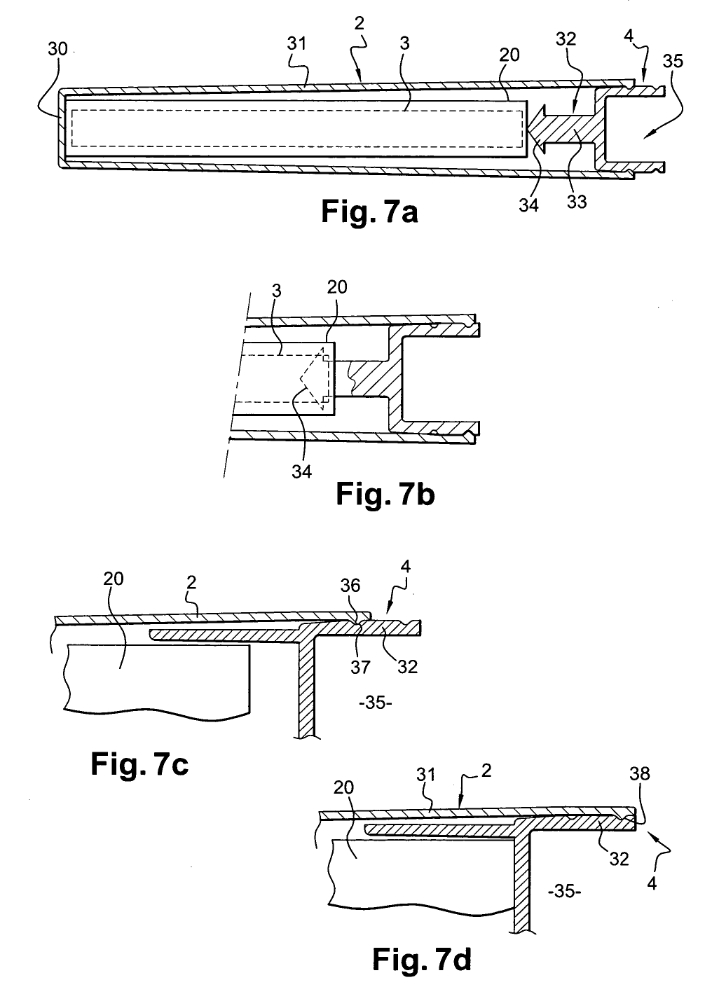

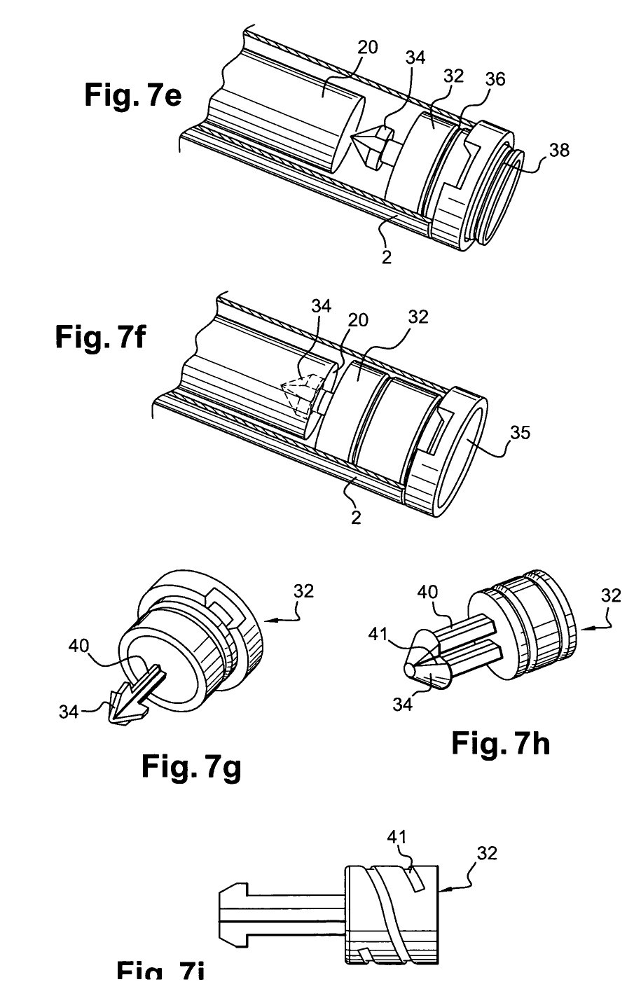

FIGS. 7a to 7i are representations of a fourth alternative of the invention,

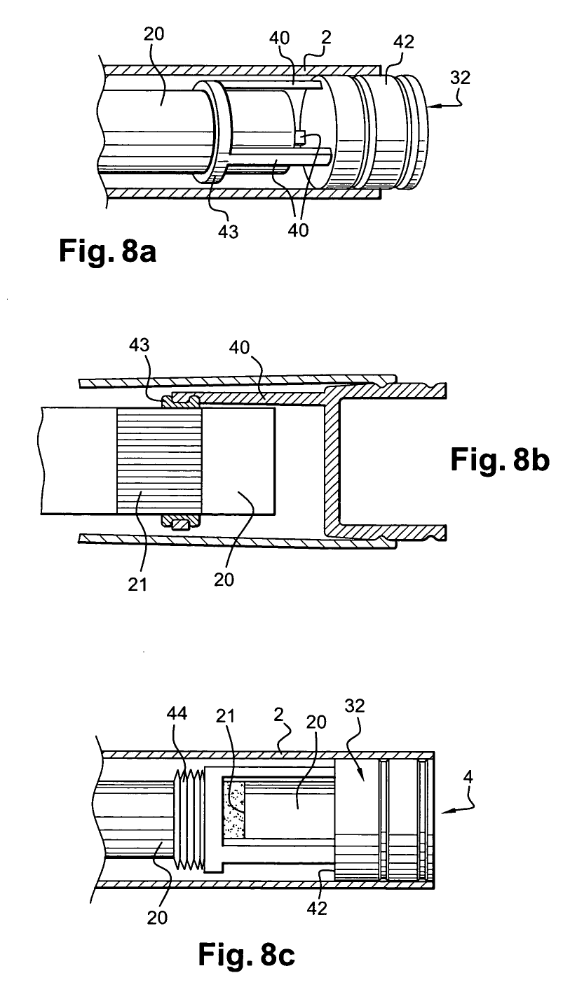

FIGS. 8a to 8c show a fifth alternative of the invention,

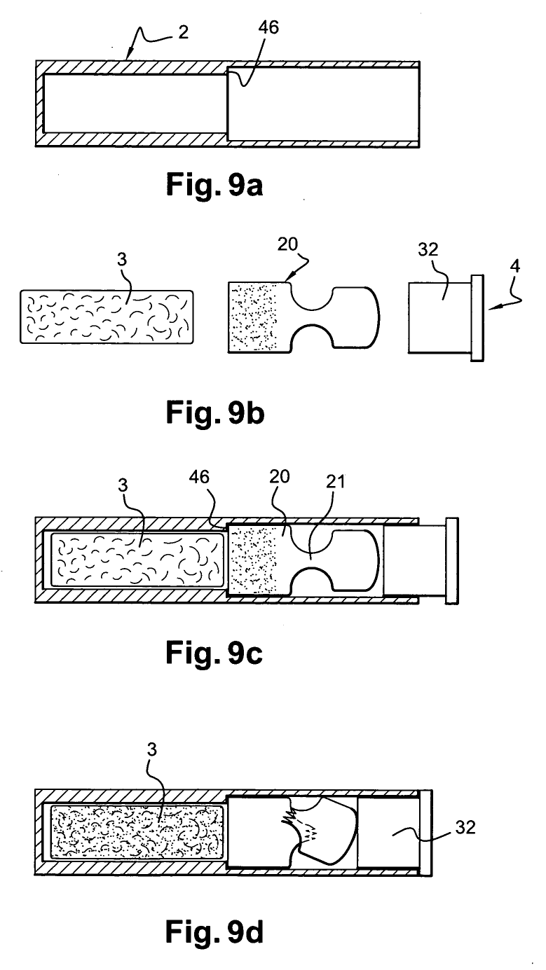

FIGS. 9a to 9d show the air treatment device according to the invention in a sixth alternative,

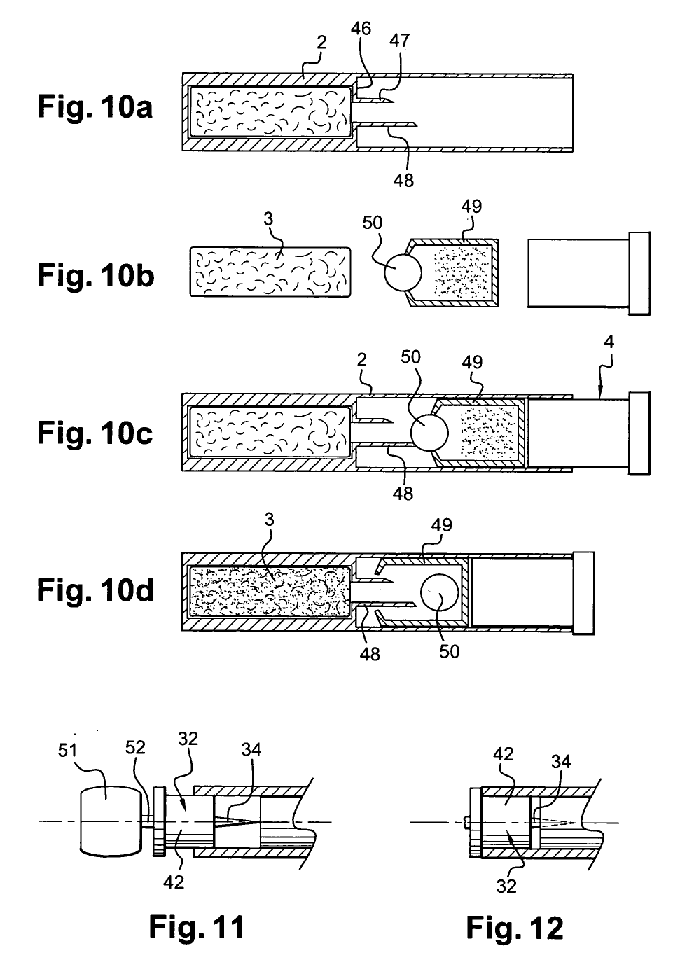

FIGS. 10a to 10d show the air treatment device in a seventh alternative embodiment,

FIGS. 11 and 12 show means for determining the state of the air treatment device.

The drawings are precise representations and can be used to define the invention if applicable.

The goal of this invention is to propose an air treatment device using a volatile treatment agent contained inside a permeable casing, which provides satisfactory, stable and continuous diffusion of the volatile agent while preventing said diffusion from occurring at inappropriate times.

Such a device is intended to be applied in particular to a ventilation, heating and/or air conditioning system of a vehicle, taking into account the constraints of initialization and installation of the device inside such a system.

Such a device is also intended to be integrated into an air filter before assembly in a ventilation, heating and/or air conditioning system. This filter is a particle type filter, an active carbon filter or a combination of the two. In air filters intended for replacement assemblies, it is understood that the air treatment device is to be activated only when assembled in the system. This prevents the volatile agent from migrating prematurely towards the filtering medium and damaging the latter, in particular in the case of an air filter using active carbon.

The volatile treatment agent can be used for disinfection, sterilization and/or deodorization of the air that circulates inside the air conditioning system. This treatment is, for example, an antimicrobial, fungicidal treatment that uses an allyl-isothiocyanate-type volatile treatment agent.

FIG. 1 shows the air treatment device 1 in a first alternative embodiment of the invention in its storage state, i.e. before activation of the emission of the volatile agent. This device consists of a casing 2 having an elongated shape into which an element 3 is slid, which element is capable of containing, maintaining or storing the volatile agent. This element can be a permeable bag containing a liquid or an active gel, or a spongy cohesive body absorbing the volatile agent. The following description will refer to a spongy cohesive body 3, but it is understood that other solutions capable of permeably containing or maintaining a volatile agent are covered by the subject matter of the invention.

This at least partially permeable casing is in particular formed by a plastic material, such as, for example, polypropylene, optionally filled with talc in a proportion between 0% and 40%, and more specifically of the order of 20%, in particular for a wall thickness between 0.5 mm and 2 mm.

In an advantageous embodiment of the invention, the inner diameter of the casing 2 is between 9 mm and 18 mm, but more specifically 11.8 mm, its length is between 40 mm and 200 mm, but more specifically 100 mm, and its thickness is between 0.85 mm and 1.10 mm, but more specifically of the order of 0.93 mm or 1.02 mm.

The casing 2 includes, on its external portion, means 4 for activating the emission of the volatile agent towards the outside of the device. It is understood that these means for activating the emission of the volatile agent consist of a physical structure integrated in or forming part of the air treatment device 1.

In the case of the first alternative, these means 4 are formed by a film or an aluminized plastic strip having a thickness of the order of 100 micrometers to 0.3 mm. This strip or film is impermeable and includes a first portion 5 connected to the casing 2, for example, by gluing, welding or thermoforming, and a second free portion 6 substantially folded above the first portion and of which the free end 18 extends beyond the treatment device 1.

FIG. 1b is a cross-section view along axis A-A shown in FIG. 1a. The presence of the spongy cohesive body 3, for example, a tubular-shaped roving, inserted into the internal volume of the casing 2. The latter has a general “V” shape formed by impermeable walls 7 and 8. This “V” shape is closed by a permeable wall having a lower thickness than that of the impermeable walls 7 and 8.

The permeable wall is referred to as an active surface 9 because it is the emission zone of the air treatment device 1. The active surface 9 has a peripheral edge 10 with a thickness greater than that of the active surface 9. This peripheral edge 10 is the area of contact, for example by gluing, between the means 4 for activating the emission of the volatile agent and the casing 2. As the first portion 5 of the film is impermeable and the attachment of the film to the peripheral edge 10 is also impermeable, it is understood that the volatile agent cannot escape through the active surface 9. The treatment device is therefore shown in this FIG. 1b in the storage position, and the volatile treatment agent shown by a plurality of dots is contained in the internal volume of the casing 2 delimited by the impermeable walls 7 and 8 and by the first portion 5 of the film.

This is not the case for the illustration shown in FIG. 1c, where it is observed that the means 4 for activating the emission of the volatile agent have been withdrawn. The treatment agent is thus capable of passing through the effective surface 9 so as to spread inside the ventilation, heating and/or air conditioning system as shown by the cloud of dots shown outside or around the treatment device 1.

The active surface 9 is sized with respect to both its thickness and its width and length. The criteria that determine these dimensions are based on the desired lifetime of such a treatment device as well as by the annual diffusion envisaged. By way of example, an annual diffusion of 45 mg/day of treatment agent, in particular allyl-isothiocyanate, at a constant temperature of the order of 40° C., can be effected with an effective surface 9 thickness of the order of 1.0 mm, substantially 20% for an overall surface (length by width of the effective surface 9) of 3750 mm², substantially 10%. It is therefore understood that the thickness is controlled or predetermined.

FIG. 1d shows the treatment device 1 implemented in a cabin filter 11 installed in a ventilation, heating and/or air conditioning system shown in part in this case. The treatment device 1 is slid into one of the folds of the filtering medium 12 in a state in which the means 4 for activating the emission of the volatile agent are not activated. The “V” shape of the casing 2 cooperates perfectly with the folded form of the filtering medium 12 so that the device 1 is completely integrated into the cabin filter. The treatment device 1 is of course securely connected to the medium 12 by appropriate means.

FIG. 2 is a left-side view of FIG. 1d. The cabin filter 11 is mounted transversally in the ventilation system. The latter has a first wall 13 that acts as a base and that receives one end of the cabin filter 11, and a second wall 14 that has an opening 15 through which the filter is inserted. The air tightness can be created directly between the second wall 14 of the system and the cabin filter 11, but it can also be created by covering the opening 15 with a cover (not shown) attached to the second wall 14.

The treatment device 1 is in the storage state since the means 4 for activating the emission of the volatile agent are attached in a sealed manner to the casing 2. The second portion 6 of the means 4 passes through the opening 15 and therefore becomes accessible via the free end 18 to a user or to an automobile mechanic preparing to deliver the vehicle equipped with this air treatment device. The access to the free end 18 of the second portion 6 is dependent on the location of the treatment device 1 in the air conditioning system. When the device is separate from the filter, the end of the second portion 6 can be made accessible by extending beyond the air conditioning system through the opening necessary for insertion of the treatment device. Access can be achieved through the glove compartment, the front foot zone of the vehicle or through the water separator. When the air treatment device is integrated into the cabin filter, access to the free end 18 of the strip or means 4 for activating the emission of the volatile agent is determined by the positioning of the filter. As the latter is a part intended to be replaced relatively often, it is always designed to be accessed easily. Consequently, the same applies to the access to the free end 18 of the second portion 6 of the film or strip.

FIG. 3 shows the air treatment device 1 as described in FIG. 2. The means 4 for activating the emission of the volatile agent are shown as being withdrawn. The user pulls on the free end 18 of the second portion 6, the film is guided as it is removed by the peripheral edge of the opening 15 so as to exert a tearing force on the first portion 5 of the film. The latter therefore rolls over itself until it is fully torn. At this stage, the air treatment device is activated by engagement of the means 4 for emitting the volatile agent, exposing the effective surface 9.

FIGS. 4a to 4d show a second alternative embodiment of the invention that satisfies an assembly constraint in a small system. In this case, the air treatment device 1 is wider than it is long, which requires the means 4 for activating the emission of the volatile agent to be adjusted.

The air treatment device 1 is therefore mounted in a wall 14 through an opening 15. FIG. 4a shows the treatment device 1 seen from the inside of the system while the means 4 for activating the emission of the volatile agent block the active surface. FIG. 4b is a top view of FIG. 4a while FIG. 4c is an illustration of the same device seen from outside the system. The free end 18 of the second portion 6 of the film extends to the outside and can therefore be grasped by a user.

FIG. 4d is a cross-section along axis B-B shown in FIG. 4d. The air treatment device 1 includes a diffusion element 3 housed in a rectangular casing 2. The effective surface 9 is located at the end of the casing 2 opposite a closing plate 17 that closes off the opening 15 formed in the system.

The active surface 9 advantageously has a crenellated form so as to increase the volatile agent emission surface while maintaining an acceptable volume.

The ends 18 of the active crenellated surface cooperate with the first portion 5 of the means for activating the emission of the volatile agent. The second portion 6 is folded over the first portion 5, then runs along one of the peripheral walls of the casing 2 so as to finally pass through the opening 15, to the outside of the system. The length necessary for withdrawal of the means 4 for activating the emission of the volatile agent is shorter than for the first alternative of the invention, while the force necessary for this withdrawal will be greater.

FIG. 5a shows a perspective view of the cabin filter on which the air treatment device 1 according to a third alternative embodiment of the invention is secured. The device is positioned at one end of the filter 11 and has a substantially cylindrical shape.

In this alternative of the invention, the internal volume of the casing 2 contains the spongy cohesive body 3, for example, a roving. This body 3 is contained inside a sealed container 20 when it has not been broken. This container is advantageously a bag tightly enclosing the spongy cohesive body 3.

This container is connected to the means 4 for activating the emission of the volatile agent. The latter is formed by a cord including a first portion 5 closely connected to the container, and a second portion 6 which extends beyond the casing 6 and of which the free end 18 can be grasped by a user.

The first portion 5 of the means 4 for activating the emission of the volatile agent is connected to the container 20 or bag to the right of the weakened areas 21 so as to facilitate the opening of the bag. In practice, these weakened areas 21 are constituted by a thinning of the wall of the container while maintaining the impermeability required before activation of the air treatment device. For example, the material used for the container 20 is polyethylene terephthalate (PET), aluminium or low-density polyethylene (LDPE) with respective thicknesses of 12 micrometers, 75 micrometers and 12 micrometers.

In the example shown in FIG. 5a, the weakened area 21 has a helical shape that extends from one end to the other of the container 20. The first portion 5 of the cord or means 4 is connected, for example by gluing, to the weakened areas 21 and therefore follows a helical path substantially identical to that of the weakened areas 21. This type of helical path is given by way of example and any other shape, for example, rectilinear, falls within the scope of the invention insofar as the container is broken so as to allow the volatile agent to be diffused inside the casing 2. In this regard, a difference is noted with respect to the previous alternatives. Indeed, the active surface 9 is not formed by a specific permeable wall of the casing. Instead, this active surface is formed by all of the peripheral walls of the casing 2, i.e. the entirety of the tubular shape of said casing. It is therefore understood that all of the walls of the casing 2 are adjusted in thickness so as to enable the volatile agent to pass through them and therefore to be diffused inside the ventilation, heating and/or air conditioning system.

The activation of the air treatment device 1 is achieved by pulling on the cord by means of the free end 18. As the cord is at least attached to one end of the container 20, a tear in said container, following the path created by the weakened areas, is created. The volatile agent is then released and can therefore perform its disinfection action, for example.

FIG. 5b shows an end of the device according to the invention. The casing is closed by a plug 22. At the intersection of the casing 2 and the plug 22, a hole 23 is provided, through which the means 4 for activating the emission of the volatile agent contained in the spongy cohesive body 3 passes. A seal 24 is installed at the periphery of the hole 23 so as to ensure the impermeability of the air treatment device when it is activated.

This figure also partially shows the connection (shown with a dotted line) that exists between the first portion 5 of the cord and the container 20.

FIG. 5c shows the difference in structure at the level of the hole 23. In this particular case, the seal 24 is replaced by an over moulded area made of a flexible material on the plug 22, the casing 2, or both on the casing and on the plug. The overmolding solution is economically more advantageous.

The structure shown in FIG. 6 is intended to solve the problem of impermeability of the casing 2 when the means 4 for activating the emission of the volatile agent are implemented. It is then necessary to prevent the volatile agent from escaping through the hole 23. To do this, at the end of the means 4 for activating the emission of the volatile agent, on the container side 2, a deformable plug 25, for example moulded on the cord, is provided. This plug 25 has a substantially cylindrical protuberance 26 equipped with an abutment 27. The casing 2 comprises a shoulder 28 directed towards the inside of the casing. This shoulder 28 as well as the thickness of the casing 2 define an area 29 for receiving the protuberance 26. The compatibility between the shapes of the protuberance 26 and the receiving area 29 ensures the impermeability necessary for proper functioning of the treatment device 1.

This compatibility between the shapes has a second function. Indeed, it indicates the state as well as the proper functioning of the withdrawal of the means 4 for activating the emission of the volatile agent. The user who pulls on the cord causes the plug 25 to become blocked against the shoulder 28, then by maintaining the pulling force on the cord, the user causes the protuberance 26 to be inserted into the receiving area 29. This insertion causes a snap which is felt by the user as a signal that the means 4 have been implemented. Alternatively, this signal can be caused by the fact that the cord breaks after the plug 25 is positioned.

This structure for sealing the casing 2 is of course applicable to the alternatives of FIGS. 1a to 3, in which the plug 25 is then connected to the end of the film stuck to the casing. In this case, the plug 25 makes it possible to close off the portion of the opening 15, necessary for the passage of the film or strip, formed in the wall 14 of the ventilation, heating and/or air conditioning casing.

It is noted that the air treatment device according to one of the alternatives described above can have another indicator of the state, provided by a mark applied to the means 4 for activating the emission of the volatile agent (on the film, the strip or the cord). This mark is an area with a different colour from the rest of the film or cord. When the user has seen this colour, he or she will know that the device has been activated by partially withdrawal of the means 4.

FIG. 7a shows the air treatment device 1 according to a fourth alternative. This device consists of the same primary elements as those described for the third alternative of the invention, i.e. a casing 2 permeable to the volatile agent contained in an element 3 (shown with a dotted line). This element, for example, an absorbent roving, is kept confined inside a container.

The casing 2 has a base 30 and a cylindrical wall 31. This casing 2 has an opening opposite the base 30. The means 4 for activating the emission of the volatile agent in the form of a percussor 32 are installed in this opening. The end 33 directed towards the inside of the casing 2 has an elongated shape with at least one perforating point 34 at the end. Of course, this percussor 32 can have a plurality of perforating points or teeth, which increase the size of the tear created in the container 20, and thus facilitates the migration of the volatile agent into the casing 2.

The other end of the percussor 32 has a recess 35 accessible to the user. It is noted that the percussor 32 is in a first position in which the container 3 is not broken, and the treatment device is therefore in the storage state.

FIG. 7b shows this same alternative of the invention in the operating position. It is noted that the means 4 for activating the emission of the volatile agent are actuated. To do this, the perforating point 34 is injected in the direction of the roving 3 so as to break the container 20 and thus enable the volatile agent contained in the roving to spread inside the casing 2, then pass through the walls of this same casing so as to act inside the ventilation, heating and/or air conditioning system.

Also as an alternative, the base 30 of the casing 2 can comprise one or more perforating points while the percussor has a flat base or at least one perforating point. In this case, the percussor pushes the container 2 in the direction of the base of the casing and punctures or breaks either at the level of the perforating point placed on the base of the casing, or on the two perforating points of the base of the casing and the percussor, so as to allow the volatile agent to diffuse.

FIGS. 7c and 7d show the system for blocking the means 4 for activating the emission of the volatile agent in the casing 2. In FIG. 7c, the percussor 32 is maintained in a first position (storage of the device) by a ring 36 moulded on the internal wall of the casing 2 near its opening. This ring 36 cooperates with a support groove 37 formed on the external wall of the percussor 32, substantially to the right of the recess 35.

FIG. 7d shows the percussor of FIG. 7c in a second position that corresponds to the tearing of the container, and therefore to the emission of the volatile agent. The external cylindrical wall of the percussor 32 has a locking groove 38 closer to the free end of the percussor 32 than the support groove 32.

In this second position, the user knows the state of the means 4 for activating the emission of the volatile agent because the percussor 32 is fully housed inside the casing 32.

The compatibility between the shapes of the locking groove 38 and the ring 36 ensures the impermeability of the casing 2 so that the level of emission is equivalent or lower than that occurring through the walls 31 of the casing 2.

FIGS. 7e and 7f show the fourth alternative with perspective views. The casing 2 is partially cut off so as to show the container 20 as well as the percussor 32. FIG. 7e corresponds to the storage position of the air treatment device in which the percussor 32 extends beyond the end of the casing 2. The perforating point 34 is in contact with the container 20 without puncturing it. This figure also shows the presence of the support groove 36 and the locking groove 38.

FIG. 7f shows the operating position of the air treatment device 1. The percussor 32 is injected into the opening provided at the end of the casing 2 and no longer extends beyond the casing. The recess 35 enables the user to optimally position his or her finger(s) in order to actuate the means for activating the emission of the treatment agent. The perforating point 34 is injected into the container 20 so as to create an opening.

FIGS. 7g to 7h show various forms of the percussor.

In FIG. 7g, the percussor 32 has a perforating point 34 in the shape of a cross, for example, with four bevelled branches to as to form a point. The perforating point 32 is connected to the percussor 32 by a single intermediate arm 30 which is also formed with a cross-shaped profile.

FIG. 7h differs from FIG. 7g by virtue of the shape of the perforating point 34. The latter has a general conical shape. The external periphery of the cone is removed so as to show at least two sharp edges 41 which actively participate in the puncturing of the container or bag. Unlike in FIG. 7g, this percussor 32 also has two intermediate arms 40 that prevent any deflection when the perforating point 34 is injected into the container.

FIG. 7i shows an alternative of the percussor 32. While the percussors shown in the previous alternatives are moved by a translation movement towards the inside of the casing 2, the percussor 32 shown in FIG. 7i is moved by the user with a rotation movement. This is why the percussor 32 has a groove 41 that performs both the support and locking functions. This groove has a general screw thread, spiral or quarter-turn shape. Thus, the rotation of the percussor 32 also causes an inward translation movement that then punctures the container.

FIGS. 8a to 8c show a fifth alternative of the device according to the invention.

The air treatment device 1 is shown partially from the side of the means 4 for activating the emission of the volatile agent. The percussor 32 that constitutes these means 4 is in the storage position. This percussor 32 has three intermediate arms 40 distributed at the periphery of the percussor body 42. At the end of the arms 40 opposite the percussor body 42 is a cylindrical ring 43 that connects each of the intermediate arms 40. It is noted that one end of the container or bag 20 passes through the cylindrical ring 43 and stops before coming into contact with the percussor body 42.

FIG. 8b is a cross-section view of the device shown in FIG. 8a. It is noted that one of the intermediate arms 40 is connected to the cylindrical ring 43. The latter is secured to the container 20, for example, by gluing, at the level of a weakened area 21 shown in the figures with hatched lines in the reverse direction of those representing the container 20. The remainder of the percussor 32 is like that described in the fourth alternative.

FIG. 8c shows the treatment device 1 according to the fifth alternative when the means 4 for activating the emission of the volatile agent have been implemented. The translation action following the pressure created by a user on the percussor 32 tears the container 20 substantially at the level of the weakened areas 21 and thus opens a window through which the volatile agent will be able to pass and fill the internal volume of the casing 2. The tearing of the container 20 is achieved by the presence of folds 44, with the extent of this tear being limited either by the contact between the percussor body 42 and the end of the container 20, or by the combination of the ring 36 with the grooves 36, 38 or 41 described in the previous alternatives.

The air treatment device 1 is shown in FIGS. 9a to 9d according to a sixth alternative embodiment.

FIG. 9a shows the casing 2. This casing has walls permeable to the volatile agent. Its internal volume is shaped according to two different diameters so as to delimit a shoulder 46.

FIG. 9b shows the elements inserted into the internal volume of the casing 2. The presence of the spongy cohesive body 3, also referred to as a roving, as well as means 4 for activating the emission of the treatment agent, in this case shown by a percussor 32, are noted.

Unlike in the previous alternatives, the volatile agent is not originally stored on or in the cohesive body 3. On the contrary, it is enclosed in liquid or gel state in a container 20 shown in this case by a blister.

FIG. 9c shows the arrangement of the elements inside the casing 2. The spongy cohesive body 3 is installed in the portion of the casing with the smallest diameter, while the container and the percussor are mounted in the portion with the largest internal diameter. One end of the container is placed in contact with the shoulder 46 and the percussor 32 is partially inserted by translation into the open end of the casing 2.

The blister has a specific shape. Indeed, it has a weakened area 21 created by a substantial shrinkage in its width or by a decrease in the thickness of one of the blister walls.

FIG. 9d shows the air treatment device after actuation of the means 4 for activating the emission of the volatile agent. The user inserts the percussor 32 by translation and breaks the blister. The volatile agent in liquid or gel phase spreads through the internal volume of the casing. It is then absorbed by the spongy cohesive body 3 which acts as a sponge. At this stage, the volatile agent is therefore maintained or contained in the spongy cohesive body 3 and the emission of the volatile agent through the wall of the casing 2 can begin.

The alternative embodiment shown in FIGS. 10a to 10d includes elements already described in FIGS. 9a to 9d. The features that differ are the presence of needles, each bevelled at its free end. Needle 47 is markedly shorter than needle 48. These two needles 47 and 48 are provided inside the casing 2, substantially at the shoulder 46, and extend in the longitudinal direction of the casing 2, with their free end being directed towards the opening of the casing.

Alternatively, these needles 47 and 48 can be replaced by a cylindrical tube of which the end directed towards the cartridge 49 is also bevelled.

FIG. 10b shows the presence of a cartridge 49 of which the opening is closed off by a ball 50. The volatile agent is thus stored in liquid or gel state in this cartridge 49 held shut by the ball 50.

FIG. 10c shows the air treatment device in the storage state, i.e. without having actuated the means 4 for activating the emission of the volatile agent. The cartridge 49 is inserted into the casing 2 and the ball 50 comes into contact with the bevelled end of the needle 48.

FIG. 10d shows the air treatment device when the means 4 are activated so as to enable the emission of the volatile agent. The translation movement of the percussor 32 towards the inside of the casing 2 causes a movement of the cartridge 49, while the ball 50 is held in position by the needle 48. The ball 50 then releases the opening of the cartridge and is then blocked in the cartridge 49. The volatile agent can then migrate towards the spongy cohesive body 3 as already explained with reference to FIG. 9d.

FIG. 11 shows a percussor 32 provided with a perforating point 34. The percussor body 42 also has means for actuating the percussor, which is not constituted by the actuation zone 35 as shown in the previous alternatives. In this case, this actuation zone is a break-off head 51 connected to the percussor body 42 by a pin 52 having a small diameter. The break-off head 51 is grasped by the user in order to implement the means for activating the emission of the volatile agent. This implementation is performed either by a rotation movement combined with a translation movement, or by a simple translation movement directed towards the inside of the casing 2. When the percussor 32 comes into contact with the wall of the casing, the excrescence is detached from the percussor by breaking the pin 52 in one of the movements indicated above.

This action has the advantage of showing the state of the means for activating the emission of the volatile agent. Indeed, when the excrescence is absent, the user knows that the device has been implemented.

This invention also relates to a method for implementing an air treatment device 1 using a volatile agent contained inside a casing that is at least partially permeable, characterized in that the activation of the emission of the volatile agent is effected according to one of the following alternatives:
by pulling on an impermeable film so as to expose an active surface of the casing,
by moving a percussor in translation towards the inside of the casing so as to break a container housing the volatile agent,
by combining a translation movement with a rotation movement so as to move a percussor towards the internal volume of the casing in order to break a container housing the volatile agent.

1. Air treatment device (1) using a volatile agent contained inside a casing (2) that is at least partially permeable, characterized in that it includes means (4) for activating the emission of the volatile agent.

2. Device according to claim 1, in which the permeability of the casing (2) is ensured by an active surface (9) of the said casing through which the volatile treatment agent passes.

3. Device according to claim 2, in which the active surface (9) is formed by a permeable wall having a lower thickness than the other walls of the casing (2).

4. Device according to claim 3, in which the means (4) for activating the emission of the volatile agent cooperate with said active surface (9) so as to keep the latter sealed before activation of the device.

5. Device according to claim 4, in which the means (4) for activating the emission of the volatile agent are constituted by an impermeable film consisting of a first portion (5) covering said active surface (9) and impermeably attached to the periphery of the active zone, and a second free portion (6) accessible to the user so as to activate the emission of the volatile agent.

6. Device according to claim 5, in which the second portion (6) of the film is folded over the first portion (5) before activation of the means (4).

7. Device according to one of claims 1 or 2, in which the volatile agent is stored in a sealed container (20) arranged inside the casing (2), wherein the means (4) for activating the emission of the volatile agent are capable of breaking the container (20) and enabling the volatile agent to spread into the casing (2).

8. Device according to claim 7, in which an active surface (9) consists of all of the peripheral walls of the casing (2).

9. Device according to either claim 7 or 8, in which the sealed container (20) is a bag with at least one weakened area (21) in its wall so as to facilitate the opening of said bag.

10. Device according to claim 9, in which the means (4) for activating the emission of the volatile agent are constituted by a cord of which one end is secured to the bag to the right of a weakened area (21) and the other end (18) is free outside the casing (2), by passing through the latter through a hole (23) so as to be accessible by the user.

11. Device according to claim 10, in which the free end (18) of the cord connected to the bag has a seal (25) intended to close off said hole (23) after activation of the means (4).

12. Device according to either claim 7 or 8, in which the means (4) for activating the emission of the volatile agent are constituted by a percussor (32) having at least one perforating point (34) capable of breaking the container (20).

13. Device according to claim 12, characterized in that the percussor (32) has a plurality of perforating points or teeth.

14. Device according to either claim 12 or 13, in which the percussor (32) is installed at one end of the casing (2) and moves in translation toward the inside of said casing so as to activate the emission of the volatile agent.

15. Device according to claim 12, characterized in that the percussor (32) moves in rotation towards the inside of the casing (2).

16. Device according to either claim 7 or 8, in which the container (20) is a blister of which one end comes into contact with a shoulder (46) formed on the internal wall of the casing (2) and the other end is subjected to the translation force of the means (4) for activating the emission of the volatile agent.

17. Device according to either claim 7 or 8, in which the container (20) is a cartridge (49) that can be perforated by at least one needle (48) provided in the internal volume of the casing (2).

18. Device according to any one of the previous claims, characterized in that it has an indicator of the state of the means (4) for activating the emission of the volatile agent.

19. Device according to claim 18, in which the state indicator is a break-off head (51) connected to the percussor (32) by a pin (52) so as to be broken off by the user when the means (4) for activating the emission of the volatile agent are implemented.

20. Device according to claim 18, in which the state indicator is a mark applied to the means (4), showing that the emission of the volatile agent has been activated.

21. Method for implementing an air treatment device (1) using a volatile agent contained inside a casing (2) that is at least partially permeable, characterized in that the activation of the emission of the volatile agent is effected by one of the following means:
by pulling on an impermeable film so as to expose an active surface of the device, or
by moving a percussor in translation towards the inside of the casing, or
by combining a translation movement with a rotation movement so as to move a percussor.
